(19) United States
(12) Patent Application Publication
(10) Pub. No.: US 2012/0185570 A1
(43) Pub. Date: Jul. 19, 2012

(54) Method and Apparatus for Indicating Switching Points in a Streaming Session

(75) Inventors: Imed Bouazizi, Tampere (FI); Miska Matias Hannuksela, Ruutana (FI)

(73) Assignee: NOKIA CORPORATION, Espoo (FI)

(21) Appl. No.: 13/187,944

(22) Filed: Jul. 21, 2011

Related U.S. Application Data
(60) Provisional application No. 61/366,497, filed on Jul. 21, 2010.

(51) Int. Cl. G06F 15/16

(52) U.S. Cl. 709/219

(57) ABSTRACT

A method, apparatus, system and computer program product are provided to provide switching point information to facilitate switching between different representations of the media content. In an instance in which a content consumption device determines that a switch from a first representation to a second representation is merited, the content consumption device may identify the appropriate switching point from the switching point information provided by the server. The content consumption device may then request the second representation of the media content beginning at the switching point.

### RELATED APPLICATION

This application claims priority to U.S. Application No. 61/366,497 filed Jul. 21, 2010, which is incorporated herein by reference in its entirety.

### TECHNOLOGICAL FIELD

An example embodiment of the present invention relates generally to a streaming session and, more particularly, relate to a method and apparatus for indicating switching points in a streaming session.

### BACKGROUND

Networking technologies and the computing devices that make use of the networking technology have evolved in such a manner as to continue to facilitate the ease of information transfer and convenience to users. In this regard, the expansion of networks and the evolution of network computing devices have provided sufficient processing power, storage space and network bandwidth to enable the transfer and playback of increasingly complex digital media files. Accordingly, internet television, video sharing and the like are gaining in popularity.

In order to facilitate the transfer and playback of digital media files, digital media files may be streamed from a server to a content consumption device, such as a computing device. Media file streaming may be accommodated by fragmenting a media file into a plurality of fragments. The content consumption device may request a segment of a media file and the server may then transmit the segment to the content consumption device in response to the request. A segment includes one or more fragments. Following the transmission and receipt of one segment, the client consumption device may request another segment from the server. This process may be repeated with the media file being transmitted from the server to the content consumption device one segment at a time.

### SUMMARY OF SOME EXAMPLES

A method, apparatus and computer program product are therefore provided according to one example embodiment for indicating switching points during the streaming of media files using a transport protocol, such as hypertext transport protocol (HTTP). By indicating switching points in accordance with example embodiments of the present invention, switching between different streamed representations may be fast and smooth. Additionally, the content consumption device of an example embodiment may locate an appropriate switching point and fetch only the necessary media data for the target representation, thereby further increasing switching efficiency.

In one example embodiment, a method is provided that includes determining, with a processor, at least one switching point in a first representation of media content. The method also includes causing switching point information defining the at least one switching point to be signaled in association with one or more media segments of the first representation of the media content. The method further includes receiving a request for a second representation of the media content based on a respective switching point that was determined in the first representation of the media content and causing one or more media segments of the second representation of the media content to be transmitted.

In another example embodiment, an apparatus is provided that includes at least one processor and at least one memory including computer program code with the at least one memory and the computer program code being configured to, with the at least one processor, cause the apparatus to at least determine at least one switching point in a first representation of media content and cause switching point information defining the at least one switching point to be signaled in association with one or more media segments of the first representation of the media content. The at least one memory and the computer program code are also configured to, with the at least one processor, cause the apparatus to receive a request for a second representation of the media content based on a respective switching point that was determined in the first representation of the media content and cause one or more media segments of the second representation of the media content to be transmitted.

In a further example embodiment, an apparatus is provided that includes means for determining at least one switching point in a first representation of media content and means for causing switching point information defining the at least one switching point to be signaled in association with one or more media segments of the first representation of the media content. The apparatus of this embodiment also includes means for receiving a request for a second representation of the media content based on a respective switching point that was determined in the first representation of the media content and means for causing one or more media segments of the second representation of the media content to be transmitted.

In yet another example embodiment, a computer program product is provided that includes at least one computer-readable memory having computer-executable program code instructions stored therein that, upon execution by a processor, cause performance of a method that includes determining at least one switching point in a first representation of media content and causing switching point information defining the at least one switching point to be signaled in association with one or more media segments of the first representation of the media content. The method performed upon execution of the computer-executable program code instructions of this embodiment also includes receiving a request for a second representation of the media content based on a respective switching point that was determined in the first representation of the media content and causing one or more media segments of the second representation of the media content to be transmitted.

In one example embodiment, a method is provided that includes receiving switching point information defining at least one switching point in a first representation of media content and determining, with a processor, that a switch is to be made from the first representation of the media content to a second representation of the media content. The method of this embodiment also includes identifying a respective switching point at which to switch from the first representation of the media content to the second representation of the media content. In this regard, the respective switching point may be identified based upon the switching point information that was received. The method of this embodiment further includes causing a request to be issued for one or more media segments of the second representation of the media content based on the respective switching point that was identified.

In another example embodiment, an apparatus is provided that includes at least one processor and at least one memory including computer program code with the at least one memory and the computer program code configured to, with the at least one processor, cause the apparatus to at least receive switching point information defining at least one switching point in a first representation of media content and determine that a switch is to be made from the first representation of the media content to a second representation of the media content. In this embodiment, the at least one memory and the computer program code are also configured to, with the at least one processor, cause the apparatus to at least identify a respective switching point at which to switch from the first representation of the media content to the second representation of the media content. In this regard, the respective switching point may be identified based upon the switching point information that was received. The at least one memory and the computer program code are also configured to, with the at least one processor, cause the apparatus to at least cause a request to be issued for one or more media segments of the second representation of the media content based on the respective switching point that was identified.

In a further example embodiment, an apparatus is provided that includes means for receiving switching point information defining at least one switching point in a first representation of media content and means for determining that a switch is to be made from the first representation of the media content to a second representation of the media content. The apparatus of this embodiment also includes means for identifying a respective switching point at which to switch from the first representation of the media content to the second representation of the media content. In this regard, the respective switching point may be identified based upon the switching point information that was received. The apparatus of this embodiment further includes means for causing a request to be issued for one or more media segments of the second representation of the media content based on the respective switching point that was identified.

In yet another example embodiment, a computer program product is provided that includes at least one computer-readable memory having computer-executable program code instructions stored therein that, upon execution by a processor, cause performance of a method that includes receiving switching point information defining at least one switching point in a first representation of media content and determining that a switch is to be made from the first representation of the media content to a second representation of the media content. The method performed upon execution of the computer-executable program code instructions of this embodiment also includes identifying a respective switching point at which to switch from the first representation of the media content to the second representation of the media content. In this regard, the respective switching point may be identified based upon the switching point information that was received. The method performed upon execution of the computer-executable program code instructions of this embodiment also includes causing a request to be issued for one or more media segments of the second representation of the media content based on the respective switching point that was identified.

In one example embodiment, a system is provided that includes a server configured to determine at least one switching point in a first representation of media content and then to signal switching point information defining the at least one switching point in association with one or more media segments of the first representation of the media content. The system of this embodiment also includes a content consumption device configured to receive the switching point information, to determine that a switch is to be made from the first representation of the media content to a second representation of the media content, to identify a respective switching point at which to switch from the first representation of the media content to the second representation of the media content based upon the switching point information that was received and to issue a request to the server for one or more media segments of the second representation of the media content based on the respective switching point that was identified.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates stream switching using open groups of pictures (GOPs) in which the shaded blocks represent pictures that have been decoded;

FIG. 2 illustrates stream switching using open GOPs in which the GOP patterns of the bitstreams are different and in which the shaded blocks represent pictures that have been decoded;

FIG. 3 illustrates a system for facilitating streaming of media files using a transfer protocol according to an example embodiment of the present invention;

FIG. 4 is a schematic block diagram of a mobile terminal according to an example embodiment of the present invention;

FIG. 5 is a flowchart illustrating operations performed for facilitating streaming of media files according to an example embodiment of the present invention;

FIG. 6 is a flowchart illustrating operations performed by a server according to an example embodiment of the present invention;

FIG. 7 is a graphical representation of the switching point information provided in accordance with an example embodiment of the present invention;

FIG. 8 is a flowchart illustrating operations performed by a content consumption device according to an example embodiment of the present invention;

FIG. 9 illustrates stream switching at a non-infra picture in accordance with an example embodiment of the present invention in which the shaded blocks represent pictures that have been decoded;

FIG. 10A illustrates an International Organization for Standardization (ISO)-based media file format (ISOFF)-compliant structured media file that may be formatted in accordance with one example embodiment of the invention; and

FIG. 10B illustrates an ISOFF-compliant structured media file that may be formatted in accordance with another example embodiment of the invention.

### DETAILED DESCRIPTION

Some embodiments of the present invention will now be described more fully hereinafter with reference to the accompanying drawings, in which some, but not all embodiments of the invention are shown. Indeed, it should be appreciated that many other potential embodiments of the invention, in addition to those illustrated and described herein, may be embodied in many different forms. Embodiments of the present invention should not be construed as limited to the embodiments set forth herein; rather, the embodiments set forth herein are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

HTTP streaming is emerging as a practical alternative to classical media delivery methods such as Moving Picture Expert Group (MPEG)-2 transport streams and Real-Time Transport Protocol (RTP). Even though HTTP was not designed for the delivery of real-time media, HTTP provides benefits that make it attractive for streaming media content delivery applications. In this regard, HTTP is relatively easy to setup and deploy. HTTP also runs on top of a transport protocol, such as transmission control protocol (TCP), in order to provide reliable and in-order delivery of media packets. Additionally, HTTP media delivery may utilize ports that are allowed to bypass firewalls and network address translation (NAT) devices that may hinder other streaming methods. Further, HTTP is widely deployed with a very robust infrastructure, including HTTP proxy servers and caches, that enables efficient data distribution.

Adaptive HTTP streaming solutions may be proprietary, such as Microsoft Smooth Streaming, or standardized solutions. In Release 9 of the Third Generation Partnership Project (3GPP) Packet Switched Streaming, a standardized solution for adaptive HTTP streaming is provided. The 3GPP adaptive HTTP streaming solution is based on the Third Generation Platform (3GP) file format, published as 3GPP Technical Specification 26.244, which inherits the concept and structure of the International Standardization Organization (ISO) Base Media File Format, here referred to as ISOFF. In addition, the 3GPP adaptive HTTP streaming solution defines the session initiation procedure, which is based on an eXtensible Markup Language (XML) file, namely, the Media Presentation Description (MPD)

As noted above, the 3GP file format for adaptive HTTP streaming is based on the IS OFF, which is jointly specified by Moving Picture Experts Group (MPEG) and Joint Photographic Experts Group (JPEG). ISOFF is published as ISO/IEC International Standard 14496-12 also known as MPEG-4 Part 12 specification. The ISOFF is designed according to an object-oriented structure in which data is arranged in boxes. Boxes may inherit from other boxes and be extended with new information fields. In the MPEG-4 Part 12 specification, each box is assigned a 4 character code that is used to identify the box type. If the parser encounters a box of an unrecognized type, the parser may safely skip the box of the unrecognized type to the beginning of the next box. This ability to skip a box of an unrecognized type is enabled by a length indicator that is part of the generic box and which is inherited by all sub-types.

The IS OFF enables the storage of metadata and media data side-by-side in one file. The media data is stored as a set of contiguous media samples in an “mdat” box. The metadata is typically stored in a variety of different boxes, such as a “ftyp” box, a “moov” box and/or a “moof” box. The “ftyp” box indicates the version of the file and the compatible brands. This information provides a parser with a hint on whether the parser would be capable of parsing the file or not. The “moov” box contains information about the media file, its components, e.g., tracks, the media codecs used, the timing and location of each media sample. Alternatively, the media sample information may be available in the “moof” box, if the media file is fragmented. Fragmentation of the media file serves several purposes, such as error robustness and spread of the file metadata.

In HTTP streaming, a media presentation may extend over one or more time periods. For each time period, there may be one or more representations of the content of the media presentation. For a particular time period, the different representations may be encoded at different bitrates and/or with different characteristics. The content consumption device may then able to select an appropriate media representation at the beginning of the period and to also switch between representations during the period. This ability to switch enables rate adaptation in HTTP streaming, as the content consumption device may select the representation that most closely matches its available throughput and may then switch between representations as the available throughput changes. A representation consists of an initialization segment and one or more following media segments. The initialization segment consists of the “ftyp” and “moov” boxes. The media segments consist of one or more media fragments. As noted above, the structure of the media presentation is described by the MPD.

HTTP and other types of streaming may provided for random access, that is, the ability of the content consumption device to begin decoding a stream at a point other than the beginning of the stream and to recover an exact or approximate representation of the decoded stream. A random access operation is characterized by a random access point and a recovery point. The random access point may be any coded frame or picture where decoding may be initiated, while the recovery point may be that point in the stream at which all subsequent decoded frames, in output order, are correct or approximately correct in content. If the random access point is the same as the recovery point, the random access operation is instantaneous; otherwise, the random access operation is gradual.

Random access may be utilized in various scenarios. For example, random access points enable seek, fast forward and fast backward operations in locally stored media streams. In video on-demand streaming, for example, servers may respond to seek requests by transmitting data starting from the random access point that is closest to the requested destination of the seek operation. Switching between coded streams of different bit-rates, such as at a random access point, may be used in unicast streaming for the Internet to match the transmitted bitrate to the expected network throughput and to avoid congestion in the network. Furthermore, random access points enable tuning in to a broadcast or multicast. In addition, a random access point can be coded as a response to a scene cut in the source sequence or as a response to an intra picture update request.

Conventionally, each intra picture has been a random access point in a coded sequence. However, the introduction of multiple reference pictures for inter prediction caused an intra picture to not necessarily be sufficient for random access. For example, a decoded picture before an intra picture in decoding order may be used as a reference picture for inter prediction after the intra picture in decoding order. Therefore, an Instantaneous Decoding Refresh (IDR) picture as specified in the H.264/Advanced Video Coding (AVC) standard or an intra picture having similar properties to an IDR picture may have to be used as a random access point. A closed group of pictures (GOP) is such a group of pictures in which all pictures can be correctly decoded. In H.264/AVC, a closed GOP starts from an IDR access unit, or from an intra coded picture with a memory management control operation marking all prior reference pictures as unused. The Sync Sample box of the ISOFF is used to indicate random access points, such as IDR pictures of H.264/AVC streams.

An open GOP is such a group of pictures in which pictures preceding the initial intra picture in output order may not be correctly decodable, but pictures following the initial intra picture are correctly decodable. An H.264/AVC decoder may recognize an intra picture starting an open GOP from the recovery point Supplemental Enhancement Information (SEI) message in the H.264/AVC bitstream. The pictures preceding the initial intra picture starting an open GOP are referred to as leading pictures, which may be either decodable and non-decodable. Decodable leading pictures are such that may be correctly decoded when the decoding is started from the initial intra picture starting the open GOP. In other words, decodable leading pictures use only the initial intra picture or subsequent pictures in decoding order as reference in inter prediction. Non-decodable leading pictures are such that cannot be correctly decoded when the decoding is started from the initial intra picture starting the open GOP. In other words, non-decodable leading pictures use pictures prior, in decoding order, to the initial intra picture starting the open GOP as references in inter prediction. Amendment 1 of Edition 3 of the ISO Base Media File Format, which is also referred to as ISO/IEC International Standard 14496-12:2008, includes support for indicating decodable and non-decodable leading pictures. In this regard, the is_leading syntax element of the Sample Dependency Type box indicates whether or not a sample is a leading picture and whether or not the leading picture is decodable when beginning the decoding from the intra picture starting an open GOP.

It is noted that term GOP is used differently in the context of random access than in the context of Scalable Video Codecs (SVC). In SVC, a GOP refers to the group of pictures from a picture having temporal_id equal to 0, inclusive, to the next picture having temporal_id equal to 0, exclusive. In the random access context, a GOP is a group of pictures that may be decoded, regardless of whether any earlier pictures in decoding order have been decoded.

Gradual decoding refresh (GDR) refers to the ability to start the decoding at a non-IDR picture and recover decoded pictures that are correct in content after decoding a certain number of pictures. GDR may therefore be used to achieve random access from non-intra pictures. Some reference pictures for inter prediction may not be available between the random access point and the recovery point, and therefore some parts of the decoded pictures in the GDR period may not be reconstructed correctly. However, these parts are not used for prediction at or after the recovery point, which results in error-free decoded pictures starting from the recovery point.

GDR is generally more cumbersome both for encoders and decoders compared to instantaneous decoding refresh. However, GDR may be desirable in error-prone environments for at least two reasons. First, a coded intra picture is generally considerably larger than a coded non-intra picture. This difference in size makes intra pictures more susceptible to errors than non-intra pictures, and the errors are likely to propagate in time until the corrupted macroblock locations are intra-coded. Second, intra-coded macroblocks are used in error-prone environments to stop error propagation. Thus, it is logical to combine the intra macroblock coding for random access and for error propagation prevention, for example, in video conferencing and broadcast video applications that operate on error-prone transmission channels.

GDR may be realized with the isolated region coding method. An isolated region in a picture may contain any macroblock locations, and a picture may contain zero or more isolated regions that do not overlap. A leftover region is the area of the picture that is not covered by any isolated region of a picture. When coding an isolated region, in-picture prediction is disabled across its boundaries. A leftover region may be predicted from isolated regions of the same picture.

A coded isolated region can be decoded without the presence of any other isolated or leftover region of the same coded picture. It may be necessary to decode all isolated regions of a picture before the leftover region. An isolated region or a leftover region contains at least one slice.

Pictures, whose isolated regions are predicted from each other, are grouped into an isolated-region picture group. An isolated region can be inter-predicted from the corresponding isolated region in other pictures within the same isolated-region picture group, whereas inter prediction from other isolated regions or outside the isolated-region picture group is disallowed. A leftover region may be inter-predicted from any isolated region. The shape, location, and size of coupled isolated regions may evolve from picture to picture in an isolated-region picture group.

An evolving isolated region may be used to provide GDR. In this regard, a new evolving isolated region is established in the picture at the random access point, and the macroblocks in the isolated region are intra-coded. The shape, size, and location of the isolated region evolve from picture to picture. The isolated region may be inter-predicted from the corresponding isolated region in earlier pictures in the GDR period. When the isolated region covers the whole picture area, a picture completely correct in content is obtained when decoding started from the random access point. This process may also be generalized to include more than one evolving isolated region that eventually covers the entire picture area.

There may be tailored in-band signaling, such as the recovery point supplemental enhancement information (SEI) message, to indicate the gradual random access point and the recovery point for the content consumption device. Furthermore, the recovery point SEI message may include an indication whether an evolving isolated region is used between the random access point and the recovery point to provide GDR.

Recovery points or random access points may be indicated in the ISOFF with the Random Access Recovery Point sample grouping, such as specified in clause 10.1 of the ISOFF Edition 3. The definition of the sample grouping allows the marking to occur at either the beginning of the recovery period or the end. The sample grouping indicates the number of samples in the recovery period. The sample grouping may be used to indicate intra pictures starting an open GOP, in which case the recovery period is zero. The sample grouping may also be used to indicate gradual decoding refresh, in which case the indicated recovery period is non-zero.

As noted above, HTTP streaming provides for bitrate adaptation by switching between different bitstreams of the same content. Switching to a different bitstream may naturally be done at any intra picture starting a closed GOP, such as an IDR picture. In order to permit more rapid adjustments to the bitrate while avoiding the compression penalty of frequent intra pictures, stream switching has been proposed to be done starting from non-intra pictures. In this regard, Färber and Girod proposed S frames that are inter-coded frames used only when switching from a first stream to a second stream. See N. Farber and B. Girod, “Robust H.263 compatible video transmission for mobile access to video servers,” Proceedings of IEEE International Conference on Image Processing (ICIP), vol. 2, pp. 73-76, October 1997. S frames are encoded with a small quantization step and make the decoded S frame close, but typically not identical, to the corresponding decoded picture of the second stream. H.264/AVC includes the feature known as SI/SP pictures as described by M. Karczewicz and R. Kurceren, “The SP- and SI-frames design for H.264/AVC,” IEEE Transactions on Circuits and Systems for Video Technology, vol. 13, no. 7, pp. 637-644, July 2003. SI/SP pictures may be used similarly to S frames, but provide identical decoded pictures after switching compared to decoding of the stream from the beginning. Identical decoded pictures are obtained with the cost of additional transformation and quantization in the decoding process for SI/SP pictures both in the primary streams and SI/SP pictures used only for switching.

In this regard, switching pictures are stored in switching picture tracks, which are tracks separate from the current track and the target track. Switching picture tracks may be identified by the existence of a specific required track reference in that track. A switching picture is an alternative to the sample in the target track that has exactly the same decoding time. If all switching pictures are SI pictures, then no further information is needed.

If any of the pictures in the switching track are SP pictures, then two extra pieces of information may be needed. First, the source track that is being switched from must be identified by using a track reference. Second, the dependency of the switching picture on the samples in the source track may be needed so that a switching picture is only used when the pictures on which switching picture depends have been supplied to the content consumption device.

This dependency is represented by means of an optional extra sample table. There is one entry in the extra sample table per sample in the switching track. Each entry records the relative sample numbers in the source track on which the switching picture depends. If this array is empty for a given sample, then that switching sample contains an SI picture. If the dependency box is not present, then only SI-frames shall be present in the track.

A switching sample may have multiple coded representations with different dependencies. For AVC video, the multiple representations of a switching sample are stored in different switching tracks. For example, one switch track may contain a SP-picture representation dependent on some earlier samples, used for stream switching, while another switch track may contain another representation as an SI-picture, used for random access.

In HTTP streaming, the switching from one representation of content to another is advantageously performed with perfect or near-perfect synchronization, that is, media-sample synchronization, to avoid overlaps or gaps in the media timeline as well as pauses in the media playback.

Upon deciding to perform a switch operation and to ensure the desired synchronization, a content consumption device generally has to: select the appropriate representation, fetch the media segment that roughly corresponds to the current playback point, locate a switch point and determine its representation time, e.g., locate an IDR or an I picture, playback the content from the first representation until the representation time of the switch point from the second representation and then playback the content from the second representation starting from the determined switch point. This switch operation is performed for each media component of the representations, e.g., both audio and video representations. Unfortunately, these switch operations may cause significant delay that may lead to interruptions in the playback.

As noted above, switch points may be defined in various manners, such as the use of IDR pictures or I pictures or the use of SP and SI pictures and/or the use of GDR, such as in an error-prone transmission. By way of example, however, stream switching in HTTP streaming may use open GOPs.

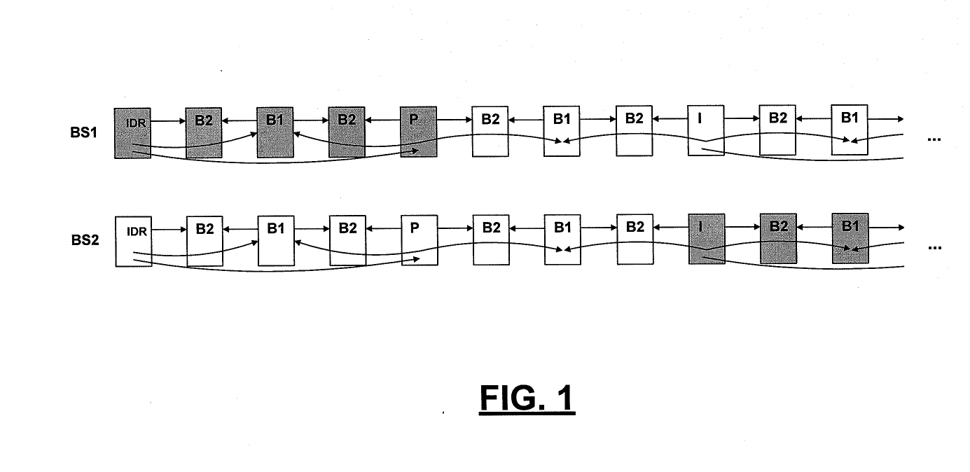

Stream switching in HTTP streaming using open GOPs may create challenges in properly handling leading pictures as illustrated with reference to FIG. 1. In the example of FIG. 1, two bitstreams, BS1 and BS2, are illustrated with the output order of pictures running from left to right, although the decoding order in this example differs from the output order. Pictures are indicated with rectangles, and the picture type is indicated within the rectangle as IDR, intra (I), inter (P), or bi-predicted (B). For B pictures, a value of temporal_id greater than 0 is indicated as a number after the picture, e.g., B1 and B2. The arrows indicate the inter prediction relationship with the source of the arrow being utilized as a reference picture for the picture to which the arrow is pointing.

In the illustrated example, a switch from BS1 to BS2 is made at the I picture. As will be noted, B2, B1 and B2 that immediately precede the I picture in output order depend, at least partially, upon the I picture for decoding and, as such, are leading pictures. If B2, B1 and B2 that immediately precede the I picture are treated as non-decodable leading pictures, their omission will cause a gap in the playback, which is generally not preferred.

Alternatively, the I picture may be received and decoded from both bitstreams, BS1 and BS2. A choice may then be made between receiving and decoding the leading pictures from BS1 or receiving and decoding the leading pictures from BS2. If the choice is made to receive and decode the leading pictures from BS1, the leading pictures of BS2 are also generally received, as they follow the I picture in decoding order. Alternatively, if the choice is made to receive and decode the leading pictures from BS2, the leading pictures of BS1 need not be received or decoded. It is noted, however, that the leading pictures from BS2 will not generally be perfectly reconstructed as some of their reference pictures in the decoding process originate from BS1, whereas the leading pictures of BS2 were encoded using reference pictures from BS2. In accordance with either option, however, two I pictures are received and decoded, which consumes transmission bandwidth and might cause a small pause in the playback due to slower than real-time decoding.

In order to conserve transmission bandwidth at the expense of image quality in a situation in which the GOP structures of both bitstreams are the same as shown in FIG. 1, only one of the I pictures at the switch point is decoded, such as the I picture in BS2, thereby ensuring real-time operation without pauses. In particular, the I picture and the leading pictures of BS1 need not be transmitted, which saves transmission bandwidth. However, the leading pictures of BS2 are not perfectly reconstructed based on their reliance upon preceding pictures in BS2, which have not been decoded. However, the imperfect reconstruction of the leading pictures of BS2 will generally create only a temporary degradation of image quality, which is usually not perceived at all or is not considered annoying.

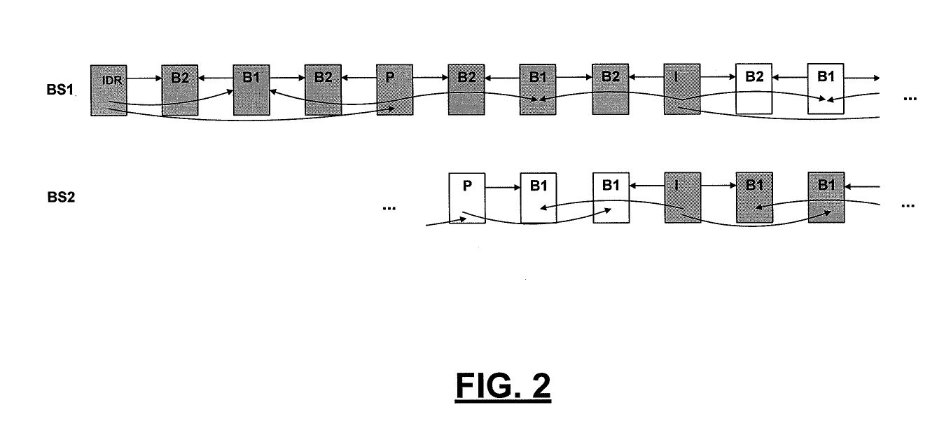

In general, however, the GOP pattern of the bitstreams need not be identical. Consequently, it is not known whether decoded pictures from one bitstream can be used as reference pictures for the other bitstream. Thus, the leading pictures of the first bitstream may be decoded, but not from the second bitstream. By way of example, FIG. 2 illustrates an example in which the GOP patterns of the bitstreams are different. As will be recognized by reference to FIG. 2, the leading pictures B1 of BS2 in this example cannot be decoded as there is no reference picture in BS1 equivalent to the P picture of BS2.

In H.264/AVC, decoded pictures are associated with various identifiers, syntax elements or variables, such as a frame number, such as indicated by the value of the frame_num syntax element of an H.264/AVC coded slice, a picture number, and a picture order count. These identifiers may be used in various decoding processes, such as implicit weighted prediction, reference picture list ordering, and reference picture marking. Even if the GOP pattern of two bitstreams is identical, some values of the respective identifiers/syntax elements/variables may differ. Consequently, a switch from one bitstream to another might result in a decoding failure due to a mismatch in some of these identifiers/syntax elements/variables. In general, the values of these identifiers/syntax elements/variables should be identical in the respective pictures in the two bitstreams to facilitate stream switching at a non-IDR picture.

As exemplified by the foregoing discussion, the content consumption device may not be able to readily determine whether the frame at the switch point and the leading frames of the source stream, such as the I-picture and the leading pictures from BS1 in the illustrated example, should be received and decoded. Additionally, the content consumption device may not be able to readily determine whether the leading frames of the target stream, such as the leading pictures of BS2 in the illustrated example, can be decoded using the reference frames of the source stream, such as the reference pictures of BS1, when necessary.

Accordingly, some example embodiments of the invention provide methods, apparatuses, and computer program products that may address some of the deficiencies of conventional media streaming techniques. For example, in order to facilitate switching between streams, such as in adaptive HTTP streaming, a method, apparatus and computer program product are provided according to embodiments of the present invention that permit switching points to be identified by a server such that a content consumption device may readily utilize the switching points to switch between different streams in an efficient manner.

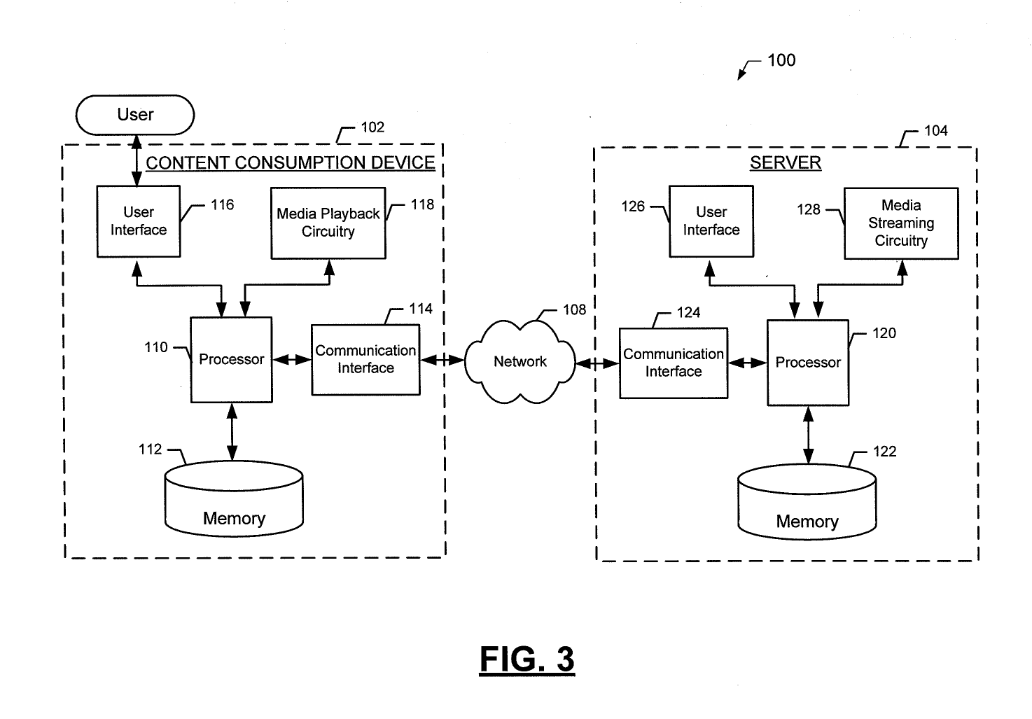

In this regard, FIG. 3 illustrates a block diagram of a system 100 for facilitating streaming of media files according to an example embodiment of the present invention. It should be appreciated, however, that the scope of the disclosure encompasses many potential embodiments in addition to those illustrated and described herein. As such, while FIG. 3 illustrates one example of a configuration of a system for facilitating streaming of media files, numerous other configurations may also be used to implement embodiments of the present invention. Further, it should be appreciated that HTTP is used as an example of an application layer transfer protocol that may be used for streaming of media files in accordance with some embodiments of the invention. Other embodiments of the invention are configured to stream media files using other application layer transfer protocols in addition to or in lieu of HTTP.

FIG. 3 illustrates a block diagram of a system 100 for streaming media files using an application layer transfer protocol, such as HTTP, according to an example embodiment of the present invention. In the illustrated embodiment, the system 100 comprises a content consumption device 102 and a server 104. The content consumption device 102 and the server 104 are configured to communicate over a network 108. The network 108, for example, comprises one or more wireline networks, one or more wireless networks, or some combination thereof. The network 108 may comprise a public land mobile network (PLMN) operated by a network operator. In this regard, the network 108, for example, comprises an operator network providing cellular network access, such as in accordance with 3GPP standards. The network 108 may additionally or alternatively comprise the internet.

The content consumption device 102 may comprise any device configured to access content from a server 104 over the network 108. For example, the content consumption device 102 comprises a server, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof, and/or the like.

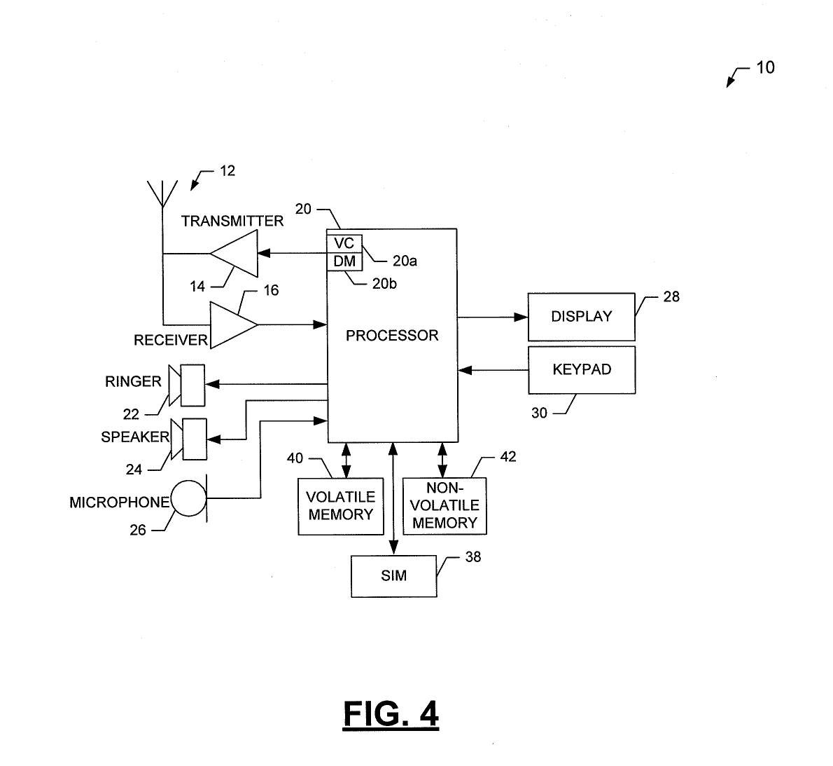

In an example embodiment, the content consumption device 102 is embodied as a mobile terminal, such as that illustrated by way of example in FIG. 4. It should be understood, however, that the mobile terminal 10 illustrated and hereinafter described is merely illustrative of one type of content consumption device 102 that may implement and/or benefit from an example embodiment of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 or multiple antennas 12 in communication with a transmitter 14 and a receiver 16. The mobile terminal may also include a processor 20 that provides signals to and receives signals from the transmitter and receiver, respectively. These signals may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones, e.g., digital/analog or TDMA/CDMA/analog phones. Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits, such as, for example, an application specific integrated circuit (ASIC) or field programmable gate array (FPGA), or some combination thereof. The processor may additionally comprise an internal voice coder (VC) 20a, an internal data modem (DM) 20b, and/or the like. Further, the processor may comprise functionality to operate one or more software programs, which may be stored in memory. For example, the processor may be capable of operating a connectivity program, such as a web browser. The connectivity program may allow the mobile terminal 10 to transmit and receive web content, such as location-based content, according to a protocol, such as Wireless Application Protocol (WAP), HTTP, and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric, e.g., 0-9, and related keys, e.g., #, *, and/or other keys for operating the mobile terminal.

As shown in FIG. 4, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology, e.g., Wibree™, radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include other a non-transitory memory including, but not limited to volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, e.g., hard disks, floppy disk drives, magnetic tape, etc., optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile terminal, such as the processor 20, for performing functions of the mobile terminal. For example, the memories may comprise an identifier, such as an international mobile equipment identification (IMEI) code, capable of uniquely identifying the mobile terminal 10.

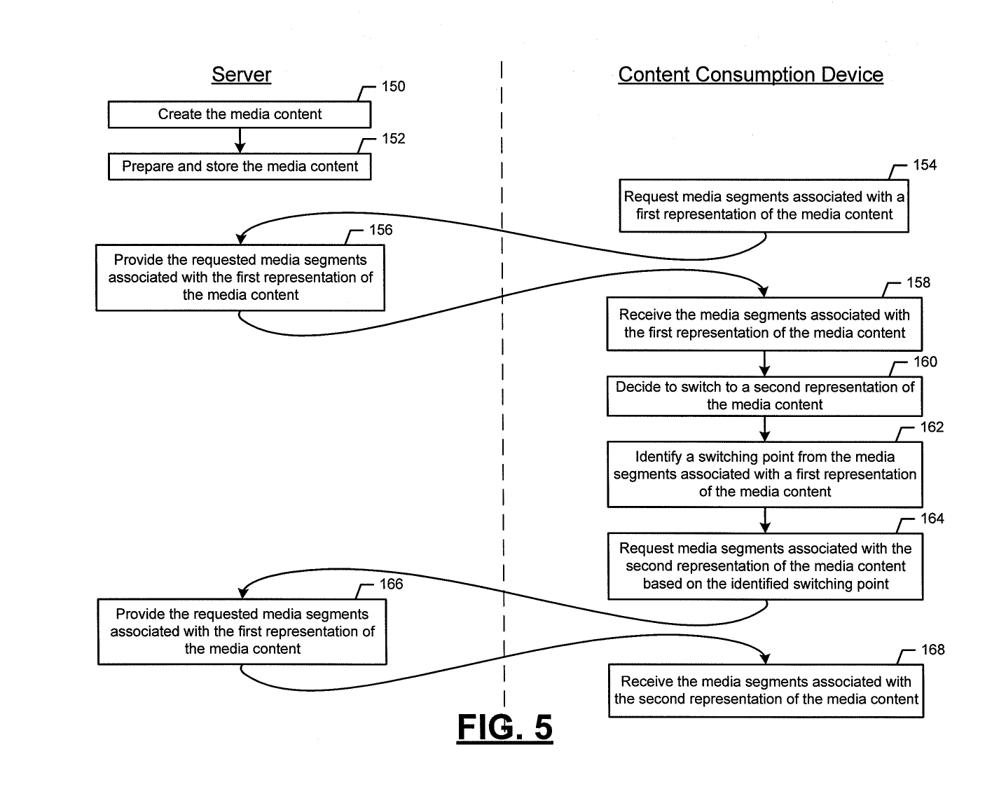

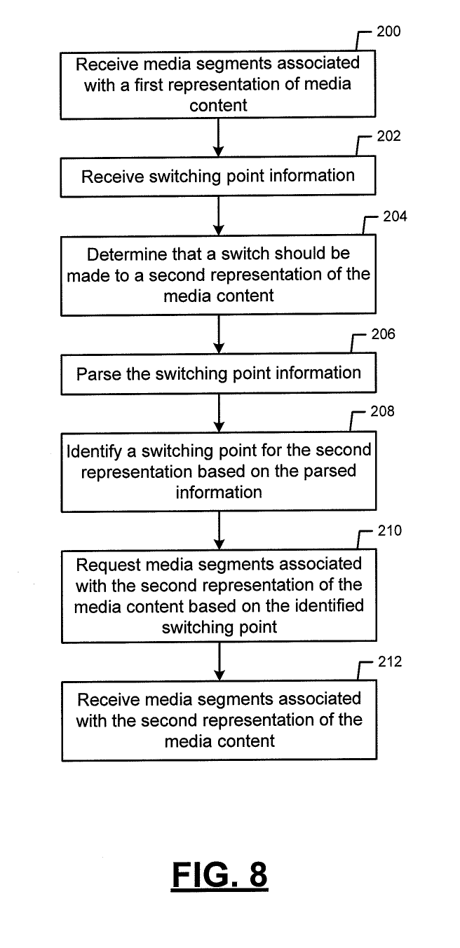

Referring again to FIG. 3, in an example embodiment, the content consumption device 102 comprises various means, such as a processor 110, a memory 112, a communication interface 114, a user interface 116, and a media playback circuitry 118, for performing the various functions herein described. The various means of the content consumption device 102 as described herein comprise, for example, hardware elements, e.g., a suitably programmed processor, combinational logic circuit, and/or the like, and/or a computer program product comprising computer-readable program instructions, e.g., software and/or firmware, stored on a computer-readable medium, e.g. memory 112. The program instructions are executable by a processing device, e.g., the processor 110. The processor 110 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC or a FPGA, or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the content consumption device 102 as described herein. In embodiments wherein the content consumption device 102 is embodied as a mobile terminal 10, the processor 110 may be embodied as or otherwise comprise the processor 20. In an example embodiment, the processor 110 is configured to execute instructions stored in the memory 112 or otherwise accessible to the processor 110. The instructions, when executed by the processor 110, cause the content consumption device 102 to perform one or more of the functionalities of the content consumption device 102 as described herein and as shown, for example, in FIGS. 5 and 8.

As such, whether configured by hardware or software operations, or by a combination thereof, the processor 110 may represent an entity capable of performing operations according to an example embodiment of the present invention when configured accordingly. For example, when the processor 110 is embodied as an ASIC, FPGA or the like, the processor 110 may comprise specifically configured hardware for conducting one or more operations described herein. Alternatively, as another example, when the processor 110 is embodied as an executor of instructions, the instructions may specifically configure the processor 110, which may otherwise be a general purpose processing element if not for the specific configuration provided by the instructions, to perform one or more operations described herein.

The memory 112 may include, for example, non-transitory memory, such as volatile and/or non-volatile memory. Although illustrated in FIG. 3 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments in which the content consumption device 102 is embodied as a mobile terminal, the memory 112 may be embodied as or otherwise comprise the volatile memory 40 and/or non-volatile memory 42. The memory 112 may be configured to store information, data, applications, instructions, or the like for enabling the content consumption device 102 to carry out various functions in accordance with example embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the media playback unit 118 during the course of performing its functionalities.

The communication interface 114 may be embodied as any device or means embodied in hardware, a computer program product comprising computer readable program instructions stored on a computer readable medium, e.g., the memory 112, and executed by a processing device, e.g., the processor 110, or a combination thereof that is configured to receive and/or transmit data from/to a remote device over the network 108. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with other entities of the system 100, e.g., antenna 12, transmitter 14 and/or receiver 16 of mobile terminal 10 of FIG. 2. The communication interface 114 may be configured to receive and/or transmit data using any protocol that may be used for communications between computing devices of the system 100. The communication interface 114 may additionally be in communication with the memory 112, user interface 116, and/or media playback circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms, e.g., earphone or speaker 24, microphone 26, display 28 and/or keypad 30 of mobile terminal 10 of FIG. 4. The user interface 116 may provide an interface allowing a user to select a media file and/or media tracks thereof to be streamed from the server 104 to the content consumption device 102 for playback on the content consumption device 104. In this regard, video from a media file may be displayed on a display of the user interface 116 and audio from a media file may be audibilized over a speaker of the user interface 116. The user interface 116 may be in communication with the memory 112, communication interface 114, and/or media playback circuitry 118, such as via a bus.

The media playback circuitry 118 may be embodied as various means, such as hardware, a computer program product comprising computer readable program instructions stored on a computer readable medium, e.g., the memory 112, and executed by a processing device, e.g., the processor 110, or some combination thereof and, in one embodiment, is embodied as or otherwise controlled by the processor 110. In embodiments where the media playback circuitry 118 is embodied separately from the processor 110, the media playback circuitry 118 may be in communication with the processor 110. The media playback circuitry 118 may further be in communication with the memory 112, communication interface 114, and/or user interface 116, such as via a bus.

The server 104 may comprise one or more computing devices configured to provide media files to a content consumption device 102. In at least one embodiment, the server 104 comprises one or more HTTP servers, dynamic streaming servers, content provider servers, web servers, web caches, web proxy servers, network servers or the like. While the server 104 may be the source of the media files, the server may also be an intermediary for receiving the media files from one or more content sources and for providing the media files to the content consumption device 102. In an exemplary embodiment, the server 104 includes various means, such as a processor 120, memory 122, communication interface 124, user interface 126, and media streaming circuitry 128 for performing the various functions herein described. These means of the server 104 as described herein may be embodied as, for example, hardware elements, e.g., a suitably programmed processor, combinational logic circuit, and/or the like, a computer program product comprising computer-readable program instructions, e.g., software or firmware, stored on a computer-readable medium, e.g. memory 122 that is executable by a suitably configured processing device, e.g., the processor 120, or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC or FPGA, or some combination thereof. Accordingly, although illustrated in FIG. 3 as a single processor, in some embodiments the processor 120 comprises a plurality of processors. The plurality of processors may be embodied on a single computing device or distributed across a plurality of computing devices. The plurality of processors may be in operative communication with each other and may be collectively configured to perform one or more functionalities of the server 104 as described herein. In an example embodiment, the processor 120 is configured to execute instructions stored in the memory 122 or otherwise accessible to the processor 120. These instructions, when executed by the processor 120, may cause the server 104 to perform one or more of the functionalities of server 104 as described herein. As such, whether configured by hardware or software methods, or by a combination thereof, the processor 120 may represent an entity capable of performing operations according to embodiments of the present invention when configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, the instructions may specifically configure the processor 120, which may otherwise be a general purpose processing element if not for the specific configuration provided by the instructions, to perform one or more algorithms and operations described herein.

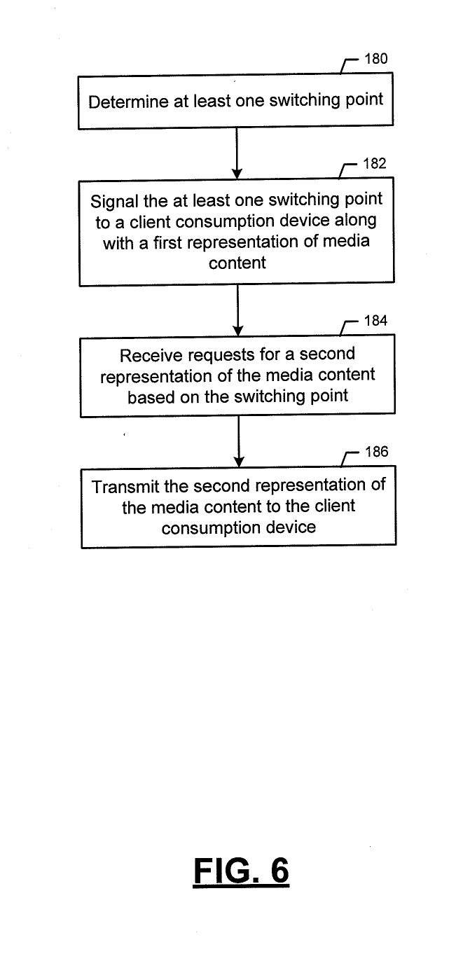

The memory 122 may include, for example, volatile and/or non-volatile memory. Although illustrated in FIG. 3 as a single memory, the memory 122 may comprise a plurality of memories, which may be embodied on a single computing device or distributed across a plurality of computing devices. The memory 122 may comprise non-transitory memory, such as volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the content provider 104 to carry out various functions in accordance with embodiments of the present invention, such as shown in FIGS. 5 and 6. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the media streaming unit 128 during the course of performing its functionalities.

The communication interface 124 may be embodied as any device or means embodied in hardware, a computer program product comprising computer readable program instructions stored on a computer readable medium, e.g., the memory 122, and executed by a processing device, e.g., the processor 120, or a combination thereof that is configured to receive and/or transmit data from/to a remote device over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122, user interface 126, and/or media streaming circuitry 128, such as via a bus.

The user interface 126 is optional and may be in communication with the processor 120 to receive an indication of a user input and/or to provide an audible, visual, mechanical, or other output to the user. As such, the user interface 126 may include, for example, a keyboard, a mouse, a joystick, a display, a touch screen display, a microphone, a speaker, and/or other input/output mechanisms. In some embodiments, the user interface 126 may be limited, or even eliminated. The user interface 126 may be in communication with the memory 122, communication interface 124, and/or media streaming circuitry 128, such as via a bus.

The media streaming circuitry 128 may be embodied as various means, such as hardware, a computer program product comprising computer readable program instructions stored on a computer readable medium, e.g., the memory 122, and executed by a processing device, e.g., the processor 120, or some combination thereof and, in one embodiment, is embodied as or otherwise controlled by the processor 120. In embodiments wherein the media streaming circuitry 128 is embodied separately from the processor 120, the media streaming circuitry 128 may be in communication with the processor 120. The media streaming circuitry 128 may further be in communication with the memory 122, communication interface 124, and/or user interface 126, such as via a bus.

As shown in operation 150 of FIG. 5, media content is initially created. In this regard, the media content may be created by the server 104 or by another source of the media content. For example, the media content may be captured, such as by one or more video cameras, one or more audio recorders or the like, or otherwise accessed, such as from a database, another device look or the like. Once created, the media content may be prepared for streaming. See operation 152. In this regard, the media content may be segmented such that the resulting media content is comprised of a plurality of segments that generally have a temporal relationship to one another. One or more of the segments may also be fragmented with a respective segment having a plurality of fragments that may also have a temporal relationship to one another. The preparation of the media content including, for example, the segmentation and fragmentation of the media content, may be performed by the server 104. Alternatively, the preparation of the media content including, for example, the segmentation and fragmentation, may be performed by a media segmenter, such as server or the like. Following its preparation, the segmented media content may be stored by or in association with a web server. See also operation 152. In this regard, the server 104 of FIG. 3 may embody the web server for storing the media content following preparation in anticipation of streaming the media content to a content consumption device 102, as described below. In regards to the embodiment of FIG. 3, the server 104 may store the segmented media content in memory 122 so as to be accessible to the processor 120 for causing streaming of the segmented media content to a content consumption device 102 upon request.

Multiple representations of the media content may be created, prepared and stored. As noted above, the different representations may differ from one another in terms of bit rate or other characteristics. Additionally, multiple types of media content for the same time period may be created, prepared and stored including, for example, video content, audio content, subtitle content and/or the like. Each different type of media content may have a plurality of different representations.

Following creation, preparation and storage, the content consumption device 102 may include means, such as the processor 110, the media playback circuitry 118, the communication interface 114 or the like, for requesting one or more media segments associated with a first representation of the media content from the server 104. See operation 154 of FIG. 5. In an example embodiment, the media playback circuitry 118 is configured to send a transfer protocol request for one or more media segments to the server 104. In an example embodiment, the requested media segments comprise media segments compliant with the ISO base media file format. Examples of an ISO base media file format comprise a 3GP media file and a moving picture experts group 4 (MPEG-4) Part 14 (MP4) file. The request, for example, may be sent in response to a user input or request received via the user interface 116.

The transfer protocol request may include an indication that the media file is to be streamed to the content consumption device 102. In an example embodiment, the transfer protocol request comprises an HTTP GET request.

In some embodiments, the media content may be prepared for streaming in operation 152 as a response to the request of media segments created in operation 154. The preparation of the media content including, for example, the segmentation and fragmentation, may be performed by a media segmenter, such as a server or the like, which may include, for example, computer program instructions in a form of a script, such as Common Gateway Interface (CGI) script, for performing the segmentation and fragmentation. A segment or a fragment prepared in operation 152 may be transferred essentially immediately from the server 104 to the content consumption device 102. In these embodiments, operation 152 may be considered to be integrally connected with and immediately preceding operation 156.

In some embodiments, media content is live or encoded in real-time or received in real-time in operation 150. Hence, operation 150 is performed simultaneously with the other operations in FIG. 5. For media segmentation and/or fragmentation, media content for a segment and/or fragment usually has to be available before preparing that segment and/or fragment in operation 152.

The server 104 of this embodiment includes means, such as the processor 120, the media streaming circuitry 128, the communication interface 124 or the like, for receiving the request from the content consumption device 102 and, in turn, providing or otherwise transmitting the requested media segment(s) associated with the first representation of the media content to the content consumption device. See operation 156. In an example embodiment, the media streaming circuitry 128 is configured to receive a transfer protocol request sent by the content consumption device 102. If the transfer protocol request includes an indication that the requested media segments are to be streamed to the content consumption device 102 and the server 104 is not configured to stream a media file, the media streaming circuitry 128 may be configured to send an error message to the content consumption device 102. However, if the server 104 is configured to stream a media file, then the media streaming circuitry 128 may be configured to include support in a reply message sent to the content consumption device 102. Such support may, for example, be indicated as part of the Pragma header field of a HTTP reply message.

In an example embodiment, the media streaming circuitry 128 is further configured to, in response to receipt of a transfer protocol request for a media file, access the requested media file from the memory 122 or other memory accessible to the server 104. The media streaming circuitry 128 of this embodiment is configured to extract at least a portion of information associated with media segments in the media file. In an example embodiment, the extracted portion of information comprises a portion of the metadata associated with media segments in the media file. For example, the extracted portion of metadata may comprise general information about the content of the media segments, e.g., the type(s) of media segments, the different tracks in the media segments and/or switching point information as described below.

The metadata associated with the media segments, for example, may be structured in accordance with the ISOFF as outlined in the table below:

| 0 | 1 | 2 | 3 | 4 | 5 | Description |
|---|---|---|---|---|---|---|
| typ | | | | | | File type and compatibility |
| oov | | | | | | Container for all metadata |
| | vhd | | | | | Movie header, overall |
| | | | | | | declarations |
| | rak | | | | | Container for an individual |
| | | | | | | trak or stream |
| | | khd | | | | Track header, overall |
| | | | | | | information in a track |
| | | ref | | | | Track reference container |
| | | dia | | | | Container for media information |
| | | | | | | in a track |
| | | | dhd | | | Media header, overall |
| | | | | | | information about the media |
| | | | dlr | | | Handler, declares the media type |
| | | | inf | | | Media information container |
| | | | | mhd | | Video media header, overall |
| | | | | | | information for video track only |
| | | | | mhd | | Sound media header, overall |
| | | | | | | information for sound track only |
| | | | | tbl | | Sample table box, container |
| | | | | | | for the time/space map |
| | | | | | tsd | Sample descriptions for the |
| | | | | | | initialization of the media |
| | | | | | | decoder |
| | | | | | tts | Decoding time-to-sample |
| | | | | | tts | Composition time-to-sample |
| | | | | | tsc | Sample-to-chunk |
| | | | | | tsz | Sample sizes |
| | | | | | tco | Chunk offset to beginning |
| | | | | | | of the file |
| | | | | | tss | sync sample table for Random |
| | | | | | | Access Points |
| oof | | | | | | Movie fragment |
| | fhd | | | | | Movie fragment header |
| | raf | | | | | Track fragment |
| | | fhd | | | | Track fragment header |
| | | run | | | | Track fragment run |
| fra | | | | | | Movie fragment random access |
| | fra | | | | | Track fragment random access |
| | fro | | | | | Movie fragment random access |
| | | | | | | offset |
| dat | | | | | | Media data container |

The IS OFF is designed in an object-oriented manner. In this regard, an ISOFF compliant file is composed of a set of boxes that may be inherited and extended through the definition of new boxes. All information in an ISOFF-compliant file must be contained in a box. A box may itself contain other boxes. Each box is identified by a unique type, which is typically defined as a 4 byte type, e.g., 4 characters. Each box also indicates the length of the box, including the header of the box. These two fields are defined by the “Box” box, which is inherited by all ISOFF boxes.

As illustrated above, ISOFF-compliant data comprises a hierarchy of a plurality of levels of metadata. Each level comprises one or more sublevels including more specific metadata related to the parent level. For example, a first level, “L0” comprises the metadata categories ftyp, moov, moof, mfra, and mdat. Ftyp and mdat may not include any sublevels. The second level, “L1” of moov may comprise, for example, mvhd and trak. The third level, “L2” of trak, for example, comprises tkhd, tref, and mdia. The fourth level, “L3” of mdia may, for example, comprise mdhd, hdlr, and minf. The fifth level, “L4” of minf may comprise vmhd, smhd, and stbl. The sixth level, “L5,” of stbl may, for example, comprise stsd, stts, ctts, stsc, stsz, stco, and stss. Accordingly, the above table represents a nested hierarchy of blocks of metadata, wherein sublevels of a block of metadata are illustrated in rows below the row including the corresponding parent metadata block and in columns to the right of the column including the corresponding parent block of metadata. Thus, all sublevels of blocks of metadata of the moov block are shown in the rows of the table below the row including the moov block until reaching the row including the “moof” block, e.g., another parent block of metadata, which is on the same level as the moov block. Similarly, all sublevels of blocks of metadata of the stbl block are shown in the rows of the table below the row including the stbl block, until reaching the row including the moof block, which is the first block at a level the same as or higher than the stbl block.

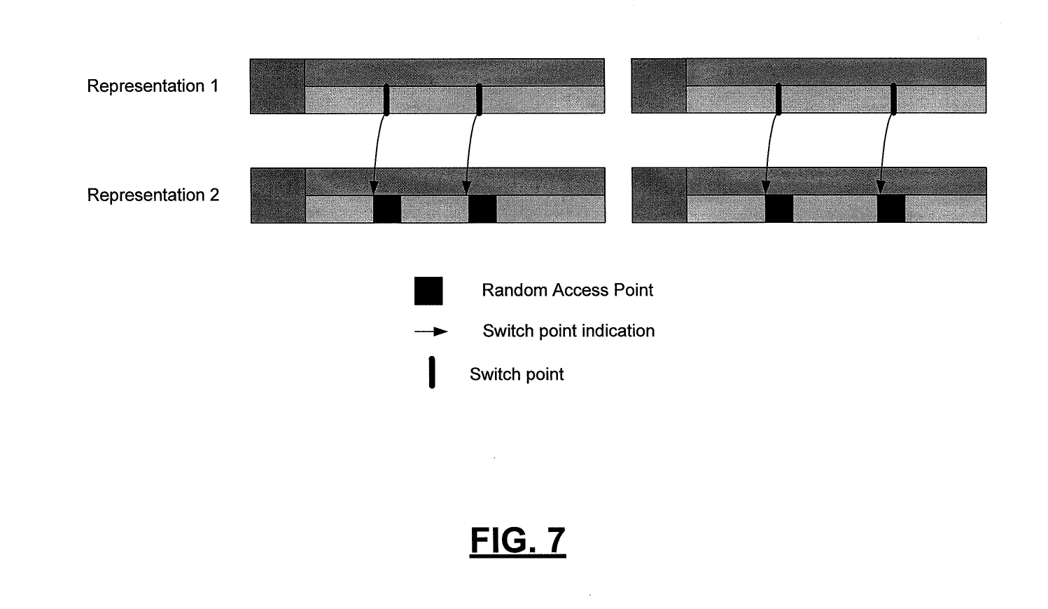

As shown in FIGS. 6 and 7, the server 104 of an example embodiment of the present invention also includes means, such as the media streaming circuitry 128, the processor 120 or the like, for determining at least one switching point at which a streaming session may be switched from one representation of media content to another representation of the same media content. As shown in FIG. 7, for example, each switching point in Representation 1 may identify a corresponding random access point in Representation 2 so as to advise the content consumption device 102 that a switch may be effectively made within the media content from Representation 1 to Representation 2 at the respective switching point. As shown in FIG. 7, the server 104 may identify multiple switching points from a first representation of the media content to a second representation of the same media content with the switching points generally being temporally spaced throughout the media content. Additionally, although FIG. 7 only illustrates the switching points from Representation 1 to Representation 2, the server 104 may have additional representations of the same media content, e.g., Representation 3, Representation 4, etc., with server 104 determining switching points between Representation 1 and each of the plurality of representations. In this regard, the switching points between Representation 1 and each of the plurality of representations may be the same or different. Although the server 104 may determine the switching points in various manners, the server of one embodiment may identify each IDR frame or I frame as a switching point, although other types of frames may also serve as switching points.

The switching points may be defined by a byte offset indication in the target representation. The byte offset indication may be either direct or indirect. A direct byte offset indication provides, usually within the switch point information structure, the byte offset within the media segment. In indirect byte offset indication, a sample corresponding to the switch point is indicated, which may then be converted to a byte offset, such as by means of the track fragment run box(es) and potentially the sample to chunk box, if present and applicable. The byte offset may be relative to the beginning of the media segment, the beginning of the media data for the track fragment run, the beginning of the file, or any other specified location within a file format structure. The location to which the byte offset is relative may be predefined in the file or segment format or the location may be indicated, for example, in the structure including the switch point information.

As described above in conjunction with operation 156 of FIG. 5, the server 104 may provide the requested media segments associated with the first representation of the media content to the content consumption device 102. The server 104 of one example embodiment also includes means, such as the media streaming circuitry 128, the processor 120 or the like, for providing the metadata associated with the media segments including signaling the switching point information associated with the first representation of the media content to the client consumption device. See operation 182 of FIG. 6.

The content consumption device 102 may include means, such as the media playback circuitry 118, the processor 110, the communication interface 114 or the like, for receiving the media segments associated with the first representation of the media content and the associated metadata including the switching point information. See operation 158 of FIG. 5 and, in more detail, in operations 200 and 202 of FIG. 8. The content consumption device 102 may store the media segments and/or the associated metadata and may also thus begin to display or otherwise output the media segments. The content consumption device 102 may repeatedly request media segments associated with the first representation of the media content from the server 104 as shown in operation 154 of FIG. 5, and the server 104 may, in turn, provide the requested media segments associated with the first representation of media content along with the associated metadata including the switching point information as shown in operation 156. The repeated requisition and provision of media segments permits the content consumption device 102 to provide a continuous output of the streaming media content.

The content consumption device 102 may include means, such as the media playback circuitry 118, the processor 110 or the like, for determining during the streaming of the media content that a switch or change should be made from the first representation of the media content to a second representation of the media content. See operation 160 of FIG. 5 and operation 204 of FIG. 8. By way of example, the media playback circuitry 118 and/or the processor 110 of the content consumption device 102 may determine that the network throughput has changed in such a manner that the bit rate associated with a different representation of the media content other than the first representation of the media content may be better suited for the current network throughput. For example, the media playback circuitry 118 and/or the processor 110 may determine that the network throughput has increased and may also determine, for example based upon the MPD, that the second representation has a greater bitrate than the first representation, but consistent with and supported by the increased network throughput. In some embodiments, the content consumption device 102 may request switching point information from the server 104, when a decision to switch to a second representation has been determined in operation 160. The request may be for example an HTTP GET request. The server 104 may then respond to the request by providing appropriate switching point information. In other embodiments, the switching point information may be readily included in the media segments including the first representation of the media content.

The media playback circuitry 118 and/or the processor 110 of the content consumption device 102 may then review the switching point information provided by the server 104 and identify an appropriate switching point at which to switch to the second representation. See operation 162 of FIG. 5 and operation 208 of FIG. 8. In one embodiment, the content consumption device 102 may receive the metadata including the switching point information, but the media playback circuitry 118 and/or the processor 110 may not parse the switching point information until the content consumption device has determined that a switch is to be made. Alternatively, the content consumption device 102 may include means, such as the media playback circuitry 118, the processor 110 and/or the like, for parsing the switching point information upon receipt or any other time prior to the determination that a switch is to be made to a different representation of the media content such that the content consumption device 102 has already identified to the switching point information prior to the determination that a switch is to be made. In either instance, the content consumption device of an example embodiment parses the switching point information and identifies an appropriate switching point at which to switch to the second representation of the media content. See operations 206 and 208 of FIG. 8.

Although the appropriate switching point may be determined in various manners, the content consumption device 102 of one embodiment identifies the next switching point from a temporal standpoint as the switching point at which to switch to the second representation of the media content. As shown in operation 164 of FIG. 5 and operation 210 of FIG. 8, the content consumption device may include means, such as the media playback circuitry 118, the processor 110 and/or the like, for requesting media segments associated with the second representation of the media content beginning at and continuing after the switching point. Consistent with the request for media segments associated with the second representation of the media content beginning at the switching point, the content consumption device 102 may cease requesting media segments associated with the first representation of the media content at and after the same switching point.

The server 104 may include means, such as the media streaming circuitry 128, the processor 120, the communication interface 124 and/or the like, for receiving the request for media segments associated with the second representation of the media content and then providing the requested media segments associated with the second representation of the media content. See operation 166 of FIG. 5 and operations 184 and 186 of FIG. 6. As described above, the server 104 may also provide metadata associated with the second representation of the media content with the metadata including, for example, switching point information for those media segments that are provided. The content consumption device 102 may include means, such as the media playback circuitry 118, the processor 110 and/or the like, for receiving, in turn, the media segments associated with the second representation of the media content along with the associated metadata. As before, the content consumption device 102 may store the metadata and may similarly store and/or display or otherwise output the media segments associated with the second representation of the media content beginning at the random access point in the second representation of the media content identified by the switching point information.

As such, the content consumption device 102 may readily identify the switching points from the switching point information provided by the server 104, thereby simplifying the determination by the content consumption device of an appropriate switching point at which to switch between representations of the media content. Thus, the content consumption device 102 may efficiently switch between different representations of the media content in a seamless manner from the perspective of the user. The process described above in conjunction with FIG. 5 may be repeated a number of times as the content consumption device 102 identifies other instances in which it would be desirable to switch from the current representation of the media content to a different representation of the media content, such as based on a change in network throughput or other parameters.

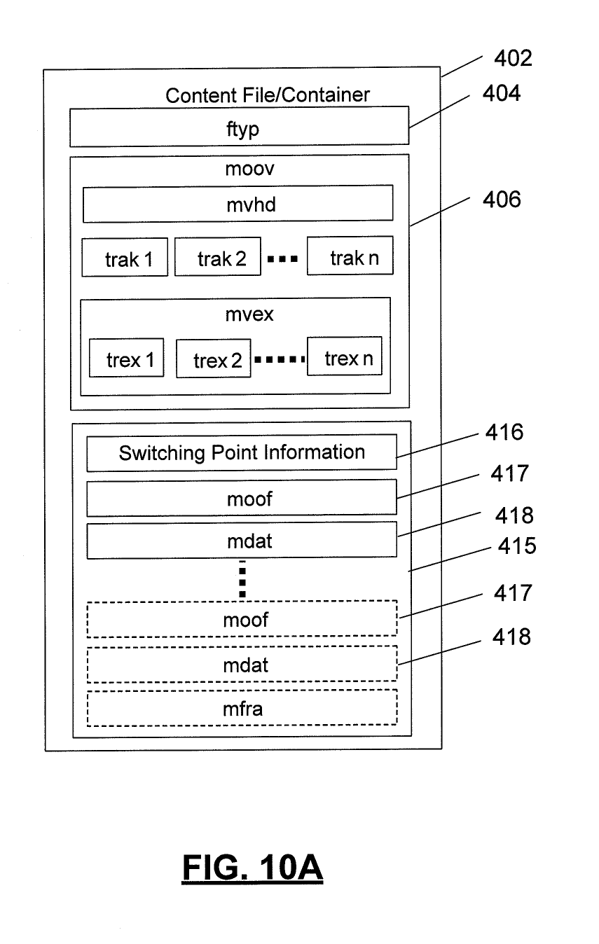

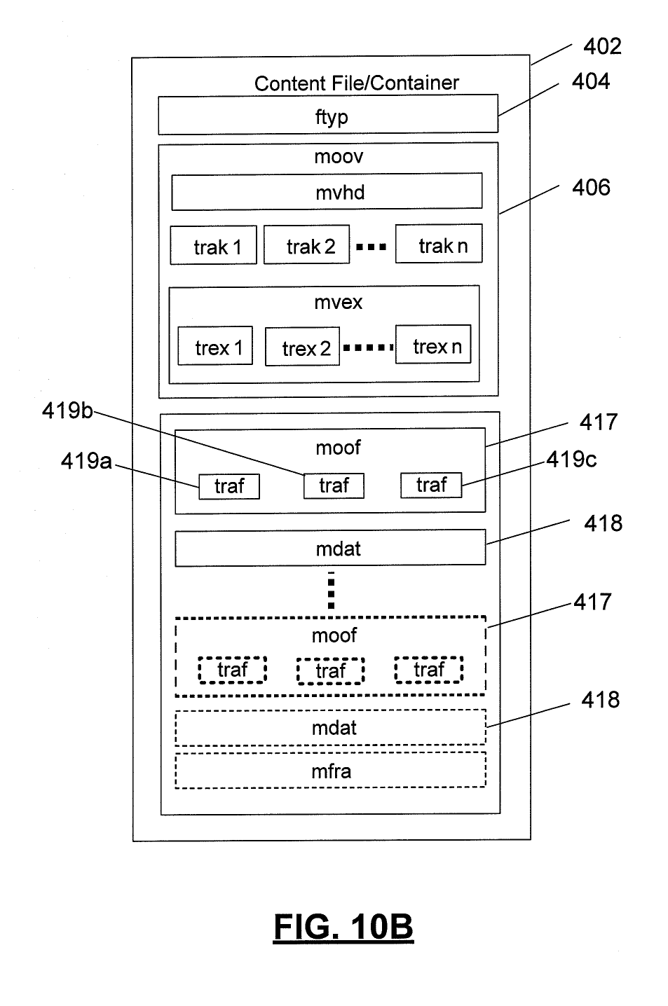

As noted above, the server 104 may provide the switching point information in various manners. In one embodiment, however, the server 104 provides the switching point information in the IS OFF-compatible media content 402 as shown in the above table and in FIGS. 10A and 10B. In one embodiment, the switching point information is provided as an independent switch point block 416, which usually follows the moov block 406 and precedes the moof and mdat blocks 417 and 418 as shown in FIG. 10A. A segment may have its own independent switch point block, that is, more than one switching point information block 416 may be present and usually precedes the first moof block of a segment. Relative to the table of the IS OFF-compatible metadata provided above, the independent switch point block 416 of this embodiment would be on Level L0 along with, for example, the ftyp 303, moov 406, moof 417 and mdat 418 boxes. As such, the switching point information provided in an independent switch point block 416 as shown in FIG. 10A would relate to each fragment within a respective media segment.

In this embodiment, the switch point may be signaled by associating a media sample with information about the target representation and the location of the random access point in the target representation. The location may simply point to the fragment that contains the random access point. As noted above, the switching point information may be expressed in a new box 416, termed spnt, as follows:

```
aligned class SwitchPointBox extends FullBox(‘spnt’, version = 0, 0) {
  unsigned int track_count;
  for (i=1; i<=track_count;i++) {
    unsigned int track_ID;
    unsigned int sample_count;
    for(j=1;j<=sample_count;j++) {
      unsigned int(32) samplenumber;
      unsigned int switch_point_count;
      for (k=1; k <= switch_point_count; k++) {
        unsigned int(32) representation_id_length;
        byte(representation_id_length) representation_id;
        signed int target_trackrefindex;
        unsigned int(1) leading_pictures_usable_flag;
        unsigned int(31) fragment_position;
      }
    }
  }
}
```

In the foregoing, track_ID and samplenumber are used to locate the media sample, e.g., the media sample that serves as the switch point in the source representation. Switch_point_count gives the number of switch points associated with this media sample. For each switch point, an indication of the target representation and the position of the random access point in the related media segment is given. A random access point is located by indicating the Representation ID (representation_id) to which the random access point belongs, the track identifier (target_track_ID) and the byte position of the fragment that contains the random access point (fragment_position).

When leading_pictures_usable_flag is equal to 0, the leading pictures in the target representation that are marked with is_leading equal to 1 should not be decoded since “is_leading=1” indicates in this context that this sample is a leading sample that has a dependency before the referenced switch point. When leading_pictures_usable_flag is equal to 1, the leading pictures in the target representation that are marked with is_leading equal to 1 may be decoded by using the reference frames of the source representation in inter prediction, when needed, since “is_leading=1” indicates in this context that this sample is a leading sample that has a dependency before the referenced switch point.

Along with the new switching point information box 416, a segment index, sidx, box may be provided. The sidx box may indicate the position and timing of the random access points in the target representation. However, the information regarding the random access points may be provided in other manners, including within the switching point information box 416. The switching point information box 416 is primarily a transport box. As indicated above, the switching point information box 416 may indicate the samples that may be switched from, the target track and the position of the switch-to sample. In this manner, once the content consumption device 102 decides that a switch is merited, the content consumption device may identify an appropriate switch point and minimize or at least reduce the content retrieval redundancy between the source and target representations of the media content.

Alternatively, switching point information may be included within each moof box. Since the metadata may include multiple moof boxes as shown in FIG. 10B, the switching point information may be similarly granular with the switching point information in a respective moof box relating to the respective fragment defined by the moof box. In one embodiment, the switching point information may be included in a track fragment box, traf, within a moof box as shown in FIG. 10B and in Level L1 in the table provided above. With reference to FIG. 10B, each moof box of the illustrated example includes three traf boxes, such as traf box 419a that provides an audio track fragment, traf box 419b that provides a video track fragment and traf box 419c that provides a hint track including the corresponding switching point information for the respective fragment. In the embodiment of FIG. 10B, it is assumed that the audio and video fragments are synchronized such that a common set of switching point information is applicable to both the audio and video fragments. However, the switching point information may be included within the moof box in other manners, such as by including additional traf boxes containing switching point information. For example, one traf box may include the hint track containing the switching point information for the audio fragment and another traf box may include the hint track containing the switching point information for the video fragment.

In this embodiment, a sample grouping is specified to indicate switch-from samples within a current track, also called source track. A switch to an indicated switch-to sample in the indicated destination track may happen at the switch-from sample as specified in more detail below.

A sample grouping in the ISO base media file format and its derivatives, such as the AVC file format and the SVC file format, is an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping has a type field to indicate the type of grouping. Sample groupings are represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These are distinguished by a type field used to indicate the type of grouping. The sample group boxes, that is, the SampleGroupDescription Box and SampleToGroup Box, reside within the sample table (stbl) box, which is enclosed in the media information (minf), media (mdia), and track (trak) boxes, in that order, within a movie (moov) box.

A sample group description entry for the switch point sample grouping may be specified as follows:

```
class VisualSwitchPointEntry( ) extends VisualSampleGroupEntry (’spnt’)
{
          unsigned int(1) leading_pictures_usable_flag;
          signed int(31) sample_count_delta;
}
```

in which sample_count_delta specifies the difference of sample counts between a switch-from sample indicated by this sample group description entry, in the track being switched from, and the switch-to sample in the track being switched to, and identified by the grouping_type_parameter. If the sample group description entry is referred from an Extended Sample to Group box within a track fragment, the sample count is relative to the track fragment. The difference is derived with respect to the sample count of the corresponding track fragment in the track being switched to. Positive values indicate the switch-to sample in the destination track has a greater sample count than the respective switch-from sample in the source track.

When leading_pictures_usable_flag is equal to 0, the leading pictures of the switch-to sample should not be decoded when the track is accessed starting from the switch-to sample. When leading_pictures_usable_flag is equal to 1, the leading pictures of the switch-to sample may be decoded by using the reference pictures of the source, when needed.

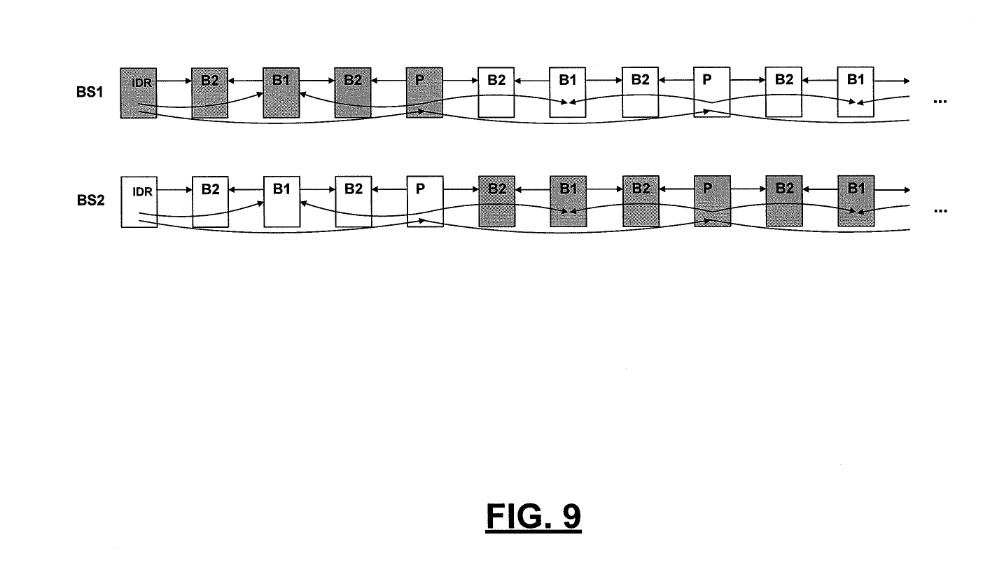

Leading pictures may be specified as those pictures preceding a switch-to frame, e.g., intra picture, in output order, succeeding the switch-to frame, e.g., intra picture, in decoding order, and having is_leading equal to 1 to indicate that this sample is a leading sample that has a dependency before the referenced switch point. Alternatively, leading pictures may be specified as those pictures preceding a switch-to frame in output order and succeeding the switch-to frame in decoding order. An example of the latter definition of a leading picture and switching at a non-intra picture is illustrated in FIG. 9. In this example, both time instances including P pictures may act as switching points. As an example, a switch from bitstream BS1 to bitstream BS2 happens in the second P picture. In this example, the leading_picture_usable_flag is set to 1 indicating the leading pictures for the switch-to P picture. It is noted that the bitstream BS2 is not perfectly reconstructed before the next intra picture, but such mismatch in decoded sample values may be tolerable or unnoticeable particularly when the switch happens from a higher-bitrate stream to a lower-bitrate stream.

In this embodiment, a Sample Group Description box is created with grouping type ‘spnt’ including sample group description entries with needed values of leading_picture_usable_flag and sample_count_delta. If the same GOP structure is used in both the switched from track and the switched to track, then usually one sample group description entry is sufficient with values leading_picture_usable_flag equal to 1 and sample_count_delta equal to 0.

A Track Reference Type box of type ‘spnt’ may be created within the Track Reference box and contains all switch-to tracks for the current track.

Version 1 of the Sample to Group box may be used as specified in Amendment 1 of the ISOFF Edition 3 as follows:

```
    aligned(8) class SampleToGroupBox
  extends FullBox(‘sbgp’, version, 0)
{
  unsigned int(32) grouping_type;
  if (version == 1) {
    unsigned int(32) grouping_type_parameter;
  }
  unsigned int(32) entry_count;
  for (i=1; i <= entry_count; i++)
  {
    unsigned int(32) sample_count;
    unsigned int(32) group_description_index;
  }
}
```

The grouping_type_parameter is set to the track reference index of type ‘spnt’ of the source track, from which this track is switched to). In this regard, grouping_type_parameter equal to 0 indicates that any track listed in the Track Reference Type box of type ‘sprit’ may be switched to at the indicated switched points.

Currently, the ISOFF allows only one Sample to Group box for a particular pair of grouping_type and grouping_type_parameter. As fragment-wise indexing may be desirable, an Extended Sample to Group box is specified. Its syntax may be identical to the syntax of the Sample to Group box as follows:

```
    aligned(8) class ExtendedSampleToGroupBox
  extends FullBox(‘esgp’, version, 0)
{
  unsigned int(32) grouping_type;
  if (version == 1) {
    unsigned int(32) grouping_type_parameter;
  }
  unsigned int(32) entry_count;
  for (i=1; i <= entry_count; i++)
  {
    unsigned int(32) sample_count;
    unsigned int(32) group_description_index;
  }
}
```

The Extended Sample to Group box of this embodiment is contained in the Track Fragment Box. In an example embodiment, there must be zero or one Extended Sample to Group boxes present having a particular pair of values of grouping_type and grouping_type_parameter in a single Track Fragment Box. When an Extended Sample to Group box is present having particular values of grouping_type and grouping_type_parameter, the Sample to Group box having the same values of grouping_type and grouping_type_parameter must not refer to any sample within the track fragment.

The parameter sample_count is relative to the track fragment that contains the Extended Sample to Group. In this example, no sample beyond the track fragment is referred to by the Extended Sample to Group box.

When sample_count is equal to 1, the sample_count parameter indicates that the present sample is a switch-from sample. When sample_count is greater than 1, it indicates that the next (sample_count−1) samples are not switch-from samples and they are followed by a switch-from sample. In other words, group description entries describe the properties of switch-from samples only and do not include an entry for samples that are not switch-from samples.

In an example embodiment, at least one Extended Sample to Group box is created for each track fragment. If the same GOP structure is used in each track, one Extended Sample to Group box with grouping_type_parameter equal to 0 may be sufficient. If the GOP structure differs between tracks, then one Extended Sample to Group box is typically created for each destination track. A determination may also be made in this embodiment as to those pictures that act as switch-from samples. For example, intra pictures starting an open GOP may be chosen as switch-from samples. In addition, all pictures having temporal_id equal to 0 may be chosen as switch-from samples, if the GOP structure is identical in all tracks.

In this embodiment, once the content consumption device 102 has determined that a switch to a second representation of the media content is desired, the content consumption device may determine the track identifier associated with the second representation based on, for example, the MPD. The content consumption device 102 may then determine a track reference index for the track identifier within the Track Reference Type box of type ‘spnt’ within the Track Reference box of the source track. If no track reference index is found, then content consumption device 102 should choose another representation.

The content consumption device 102 of this example embodiment may than parse the Extended Sample to Group box that has grouping_type equal to ‘spnt’, has grouping_type_parameter equal to 0 or the track reference index value of the desired representation, and is located in the present track fragment that is being decoded.

The content consumption device 102 of this example embodiment may then locate the closest subsequent switch-from sample to the sample that is being received or was received latest. If leading_pictures_usable_flag for the selected switch-from sample is 0, the switch-from sample and its leading pictures are received from the source track and the TCP connection is terminated afterwards. If leading_pictures_usable_flag for the selected switch-from sample is 1, the switch-from sample and its leading pictures need not be received from the source track and the TCP connection may be terminated prior to receiving the switch-from sample fully.

The content consumption device 102 of this example embodiment may then request the respective segment from the second representation from the server 104. In this regard, the content consumption device 102 may request the movie fragment, moof box, of the segment and the media data from the mdat box of the segment starting from the switch-to sample. For example, the content consumption device 102 may estimate the size of the moof box and assign an HTTP GET request with a byte range to get the moof box. The content consumption device 102 may then pipeline another HTTP GET request with a byte range for the media data starting from the switch-to sample. Alternatively, the content consumption device 102 may open two TCP connections, one for obtaining the moof box and another one for obtaining the media data starting from the switch-to sample. The TCP connection for obtaining the moof box may be terminated when the moof box has been fully received. In either instance, the content consumption device 102 may determine the byte offset of the switch-to sample within the mdat box by parsing the Track Fragment Run box(es).

In the foregoing discussion it should be appreciated that IS OFF-compliant media segments are used for purposes of example and not by way of limitation. Correspondingly, the structure of the metadata illustrated in FIGS. 10A and 10B and described in respect thereto is for purposes of example and the structure may be arranged differently in accordance with other embodiments of the invention. Additionally, the metadata of FIGS. 10A and 10B is described with respect to movie content. However, it will be appreciated that embodiments of the invention may be applied to other types of media content as well, such as audio only media content, video only media content, and audio/video media content. Although the switching point information is provided in conjunction with the metadata of the first representation of the media content, the switching point information may be provided in conjunction with the target representation or as separate information that is not included in either the first representation or the target representation. Still further, the switching point information need not be provided in an IS OFF-compliant media segment, but may be provided via a timed metadata track or may be signaled out-of-band, such as part of the MPD.

In some embodiments, switch point information is provided for a group of samples sharing a certain or indicated property. For example, it may be indicated in switch point information that each intra picture or each sample at the lowest temporal level is a switch point. Alternatively, it may be indicated that any sample is a switch point. In this instance, the GOP pattern of indicated streams is identical and any values associated with decoded pictures required in the decoding process, such as frame number and picture order count, are also identical, and hence a switch at any picture is enabled. Such a property of streams may be indicated by a track group type box of a new type, here referred to as identical bitstream structure (ibss). The track group box and track group type box are specified in Amendment 1 of IS OFF Edition 3 as follows:

```
    aligned(8) class TrackGroupBox(‘trgr’) {
}
    aligned(8) class TrackGroupTypeBox(unsigned int(32)
track_group_type) extends FullBox(track_group_type,
version = 0, flags = 0)
{
            unsigned int(32) track_group_id;
            // the remaining data may be specified for a particular
track_group_type
}
```

The tracks that have the same value of track_group_id in the track group type box of type ‘ibss’ have an identical bitstream structure. The decoded samples and the values of syntax elements and variables associated with the decoded samples of one track may be used in the decoding of samples of another track having the same value of track_group_id in the track group type box of type ‘ibss’. The decoded pictures are similar, but need not have identical sample values when decoded samples from other tracks having the same value of track_group_id in the track group type box of type ‘ibss’ are used in the decoding process.

Such switching point information for a group of samples sharing a certain or indicated property may also or alternatively be signaled out-of-band, such as part of the MPD.

FIGS. 5, 6 and 8 are flowcharts of a system, method, and computer program product according to an example embodiment of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor, e.g., processor 110 or processor 120, in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus, e.g., a content consumption device 102 and/or a server 104, to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-transitory, non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

That which is claimed is:

1. A method comprising:
determining, with a processor, at least one switching point in a first representation of media content;
causing switching point information defining the at least one switching point to be signaled in association with one or more media segments of the first representation of the media content;
receiving a request for a second representation of the media content based on a respective switching point that was determined in the first representation of the media content; and
causing one or more media segments of the second representation of the media content to be transmitted.

2. A method according to claim 1 wherein causing the switching point information to be signaled comprises causing a media file to be transmitted that contains both the switching point information and the one or more media segments of the first representation of the media content.

3. A method according to claim 2 wherein causing a media file to be transmitted comprises at least one of:
causing switching point information to be provided that is applicable to an entire media segment, and causing switching point information to be provided that is applicable to a respective media fragment.

4. A method according to claim 1 where determining at least one switching point comprises at least one of:
determining a plurality of switching points between the first representation of the media content and the second representation of the media content, and
determining a plurality of switching points between the first representation and each of a plurality of other representations of the media content.

5. A computer program product comprising at least one computer-readable memory having computer-executable program code instructions stored therein that, upon execution by the processor, cause performance of the method of claim 1.

6. An apparatus comprising at least one processor and at least one memory including computer program code, the at least one memory and the computer program code configured to, with the at least one processor, cause the apparatus to at least:
determine at least one switching point in a first representation of media content;
cause switching point information defining the at least one switching point to be signaled in association with one or more media segments of the first representation of the media content;
receive a request for a second representation of the media content based on a respective switching point that was determined in the first representation of the media content; and
cause one or more media segments of the second representation of the media content to be transmitted.

7. An apparatus according to claim 6 wherein the at least one memory and computer program code are further configured to, with the at least one processor, cause the apparatus to cause a media file to be transmitted that contains both the switching point information and the one or more media segments of the first representation of the media content.

8. An apparatus according to claim 7 wherein the at least one memory and computer program code are further configured to, with the at least one processor, cause the apparatus to perform at least one of:
cause switching point information to be provided that is applicable to an entire media segment, and
cause switching point information to be provided that is applicable to a respective media fragment.

9. An apparatus according to claim 6 where the at least one memory and computer program code are further configured to, with the at least one processor, cause the apparatus to perform at least one of:
determine a plurality of switching points between the first representation of the media content and the second representation of the media content, and
determine a plurality of switching points between the first representation and each of a plurality of other representations of the media content.

10. A method comprising:
receiving switching point information defining at least one switching point in a first representation of media content;
determining, with a processor, that a switch is to be made from the first representation of the media content to a second representation of the media content;
identifying a respective switching point at which to switch from the first representation of the media content to the second representation of the media content, wherein identifying the respective switching point comprises identifying the respective switching point based upon the switching point information that was received; and
causing a request to be issued for one or more media segments of the second representation of the media content based on the respective switching point that was identified.

11. A method according to claim 10 wherein receiving switching point information comprises receiving the switching point information in association with one or more media segments of the first representation of the media content.

12. A method according to claim 11 wherein receiving the switching point information in association with one or more media segments comprises receiving a media file that contains both the switching point information and the one or more media segments of the first representation of the media content.

13. A method according to claim 12 wherein receiving a media file that contains both the switching point information and the one or more media segments comprises at least one of:
receiving switching point information that is applicable to an entire media segment, and
receiving switching point information that is applicable to a respective media fragment.

14. A method according to claim 10 further comprising parsing the switching point information to identify one or more switching points.

15. A method according to claim 14 wherein parsing the switching point information comprises parsing the switching point information after determining that a switch is to be made.

16. A method according to claim 10 further comprising receiving one or more media segments of the second representation of the media content in response to the request.

17. A computer program product comprising at least one computer-readable memory having computer-executable program code instructions stored therein that, upon execution by the processor, cause performance of the method of claim 10.

18. An apparatus comprising at least one processor and at least one memory including computer program code, the at least one memory and the computer program code configured to, with the at least one processor, cause the apparatus to at least:
receive switching point information defining at least one switching point in a first representation of media content;
determine that a switch is to be made from the first representation of the media content to a second representation of the media content;
identify a respective switching point at which to switch from the first representation of the media content to the second representation of the media content, wherein identifying the respective switching point comprises identifying the respective switching point based upon the switching point information that was received; and
cause a request to be issued for one or more media segments of the second representation of the media content based on the respective switching point that was identified.

19. An apparatus according to claim 18 wherein the at least one memory and computer program code are further configured to, with the at least one processor, cause the apparatus to receive the switching point information in association with one or more media segments of the first representation of the media content.

20. An apparatus according to claim 19 wherein the at least one memory and computer program code are further configured to, with the at least one processor, cause the apparatus to receive a media file that contains both the switching point information and the one or more media segments of the first representation of the media content.

21. An apparatus according to claim 20 wherein the at least one memory and computer program code are further configured to, with the at least one processor, cause the apparatus to perform at least one of:
receive switching point information that is applicable to an entire media segment, and
receive switching point information that is applicable to a respective media fragment.

22. An apparatus according to claim 18 wherein the at least one memory and computer program code are further configured to, with the at least one processor, cause the apparatus to parse the switching point information to identify one or more switching points.

23. An apparatus according to claim 22 wherein the at least one memory and computer program code are further configured to, with the at least one processor, cause the apparatus to parse the switching point information after determining that a switch is to be made.

24. An apparatus according to claim 18 wherein the at least one memory and computer program code are further configured to, with the at least one processor, cause the apparatus to receive one or more media segments of the second representation of the media content in response to the request.

25. A system comprising:
a server configured to determine at least one switching point in a first representation of media content and then to signal switching point information defining the at least one switching point in association with one or more media segments of the first representation of the media content; and
a content consumption device configured to receive the switching point information, to determine that a switch is to be made from the first representation of the media content to a second representation of the media content, to identify a respective switching point at which to switch from the first representation of the media content to the second representation of the media content based upon the switching point information that was received and to issue a request to the server for one or more media segments of the second representation of the media content based on the respective switching point that was identified.
